(19) United States
(12) Patent Application Publication
(10) Pub. No.: US 2024/0429792 A1
(43) Pub. Date: Dec. 26, 2024

(54) Rotor Shaft With Separate Slip Ring Module for a Rotor of an Electric Machine

(71) Applicant: Bayerische Motoren Werke Aktiengesellschaft, Muenchen (DE)

(72) Inventors: Johannes MEYER, Karlsfeld (DE); Alexander SCHOLZ, Muenchen (DE)

(21) Appl. No.: 18/689,974

(22) PCT Filed: Oct. 25, 2022
(86) PCT No.: PCT/EP2022/079731

§ 371 Date: Mar. 7, 2024

(30) Foreign Application Priority Data
Nov. 23, 2021 (DE) 10 2021 130 559.4

(51) Int. Cl. H02K 13/00; H02K 1/24; H02K 7/08; H02K 11/21

(52) U.S. Cl. CPC H02K 13/003; H02K 1/24; H02K 7/08; H02K 11/21

(57) ABSTRACT

Please substitute the new Abstract submitted herewith for the original Abstract: A rotor shaft has a shaft part extending along the axis of rotation of the rotor and which has a rotor body region for arrangement in the rotor body. The shaft part has a carrier element that follows in the axial direction. The shaft part has grooves extending in the axial direction from an attachment region of the shaft part to the carrier element. The rotor shaft includes a slip ring module having a base element with slip rings arranged on the carrier element of the shaft part. The slip ring module electrically conductive module lines extending from the corresponding slip rings inside the corresponding grooves to the attachment region of the shaft part. The rotor shaft also includes a bearing surface, on the shaft part and/or on the slip ring module, for mounting of the rotor shaft.

### BACKGROUND AND SUMMARY

The invention relates to an electric machine such as a synchronous machine. In particular, the invention relates to a rotor shaft for a current-energized rotor of an electric machine.

A vehicle which is at least in part electrically driven comprises an electric machine for driving the vehicle. The electric machine comprises a stator which encloses a rotor of the electric machine.

The rotor shaft for a current-energized rotor can be of a multiple-part construction with separate bearing seats, wherein the slip rings for the electric power supply to the coils of the rotor are disposed in a bearing seat. The use of a multiple-part rotor shaft may lead to a reduction in the stability and/or a reduction in the mechanical load bearing capability of the rotor shaft.

The present document is focused on the technical object of providing a rotor shaft for a current-energized rotor of an electric machine, which has an increased stability, service life and mechanical load bearing capability.

The object is achieved by the independent claim. Advantageous embodiments are described, inter alia, in the dependent claims. Attention is drawn to the fact that additional features of a patent claim dependent on an independent patent claim, without the features of the independent patent claim or only in combination with a subset of the features of the independent patent claim, can form a separate invention which is independent of the combination of all the features of the independent patent claim and can be made the subject matter of an independent claim, a divisional application or a subsequent application. This applies in an analogous manner to technical teachings described in the description which can form an invention independent of the features of the independent patent claims.

Described according to one aspect is a rotor shaft for a rotor of an electric machine, in particular a current-energized electric synchronous machine. The rotor shaft comprises a shaft part which has substantially the shape of a circular cylinder, for example. The shaft part extends along the rotation axis of the rotor and can optionally be configured to be rotationally symmetrical in relation to the rotation axis (with the exception of one or a plurality of grooves in the shaft part).

The shaft part has a rotor body region for disposal in the rotor body, in particular for disposal in a central opening of the rotor body, of a rotor. The rotor body region can be configured in such a manner that the shaft part can be joined to the rotor body by means of an interference fit in the rotor body region. For this purpose, the shaft part may be cooled prior to joining to the rotor body.

In one example, the shaft part has a bearing face, which follows (the rotor body region) in the axial direction, for mounting the rotor shaft. In an alternative example, the bearing face can be disposed on the slip ring module of the rotor shaft.

The rotor body region can extend to the end face of the rotor body. The bearing face, as an extension of the shaft part in the axial direction, can be disposed next to the rotor body region (and thus next to the end face of the rotor body). A connecting region of the shaft part can be disposed between the bearing face (of the shaft part or of the slip ring module) and the rotor body region (of the shaft part). An electrical connection between the windings of the rotor and a current supply can be made in the connecting region of the shaft part.

The bearing face of the rotor shaft typically has a circular-cylindrical shape. The bearing face can be configured to receive a bearing for rotatably mounting the rotor shaft.

The shaft part furthermore comprises a support element which follows (the bearing face or the connecting region) in the axial direction. The support element here can be configured as a (circular-cylindrical) pin or bolt which extends in the radial direction away from the rotor body region and from the connecting region (and optionally from the bearing face) of the shaft part. The support element can have a smaller diameter than the bearing face and/or than the rotor body region and/or than the connecting region. In this way, a detent (at the transition between the support element and the bearing face, or the connecting region, respectively) can be formed in an efficient manner.

Furthermore, the shaft part has one or a plurality of grooves which runs/run in each case in the axial direction, from the connecting region of the shaft part (optionally disposed between the rotor body region and the bearing face) to the support element. The one or the plurality of grooves can in particular begin in each case at the detent of the shaft part and terminate in the connecting region of the shaft part. The one or the plurality of grooves herein can traverse the bearing face of the rotor shaft.

The shaft part typically has exactly two grooves (for exactly two electrical module lines). The two grooves can be mutually disposed on the shaft part at an angular spacing of 180° (i.e. exactly opposite one another). The one or the plurality of grooves can run on the external side of the wall of the shaft part.

The shaft part is preferably integrally configured and/or configured as a metallic component. Consequently, the shaft part can be joined to a rotor body in an efficient manner (due to a cold impact). Furthermore, the shaft part is preferably configured to be hollow at least in regions in order to reduce the weight of the shaft part.

The rotor shaft furthermore comprises a slip ring module (as a component which is separate from the shaft part). The slip ring module can be (substantially, in particular with the exception of the one or the plurality of module lines, and optionally with the exception of the bearing face) composed of an electrically isolating plastics material.

The slip ring module has a base element which has one or a plurality of slip rings and is disposed on the support element of the shaft part. For this purpose, the base element of the slip ring module can have a cavity which is configured to receive the support element of the shaft part, in particular in such a manner that an interference fit is formed between the base element of the slip ring module and the support element of the shaft part. The base element can in particular be configured as a (circular) hollow cylinder.

The base element can thus perform the task of fixing the slip ring module on the shaft part. The axial positioning of the slip ring module herein can take place by way of the detent of the shaft part. For this purpose, the end face of the base element (facing the rotor body region of the shaft part) can be located on the detent of the shaft part (and optionally be pressed against the detent of the shaft part by a screw).

Furthermore, the slip ring module comprises one or a plurality of (in particular exactly two) electrically conducting module lines which extend from the corresponding one or plurality of slip rings within the corresponding one or plurality of grooves of the shaft part to the connecting region of the shaft part.

Described is thus a rotor shaft which has a (single-part, metallic) shaft part which can be joined to a rotor body in an efficient and reliable manner. In a subsequent process step, the slip ring module can then be efficiently fastened to the shaft part, in particular to the support element of the shaft part, so as to provide the one or the plurality of (in particular the exactly two) slip rings, and so as to connect the one or the plurality of slip rings in an electrically conducting manner to the windings of the rotor by way of one or a plurality of corresponding module lines. A robust, durable and efficiently producible rotor shaft can be provided in this way.

As has already been set forth above, the rotor shaft has a bearing face for mounting the rotor shaft, which is disposed on the shaft part and/or on the slip ring module. The bearing face herein, in terms of the axial direction, can be disposed between the connecting region of the shaft part and the one or the plurality of slip rings of the slip ring module. In particular, the bearing face can enclose the one or the plurality of grooves and the one or the plurality of electrically conducting module lines in a radially encircling manner about the axial direction. This can effectively ensure that the bearing face is not compromised and/or interrupted by the electrical connection between the one or the plurality of slip rings and the windings of the rotor.

The bearing face can be disposed between the connecting region and the support element on the shaft part. Alternatively, the bearing face can be disposed on the slip ring module, in particular on the end of the slip ring module that faces the connecting region of the shaft part.

The one or the plurality of (in particular the exactly two) electrically conducting module lines can in each case be disposed in an electrically isolating support (e.g. of plastics material). The one or the plurality of supports herein, proceeding in each case from the end face of the base element of the slip ring module (disposed on the detent of the shaft part), can extend in the axial direction toward the connecting region of the shaft part. Furthermore, the one or the plurality of grooves can be configured to receive the corresponding one or plurality of supports. For this purpose, the individual grooves can have a shape which complements the shape of the corresponding supports, so that the individual grooves are completely filled by the corresponding supports. Owing to the individual module lines being in each case disposed in an electrically isolating support, the slip ring module can be disposed on the shaft part in a particularly efficient and reliable manner.

One or a plurality of (elastic) sealing elements for sealing the corresponding one or plurality of grooves of the shaft part in a fluid-tight manner can be disposed on the end face of the base element of the slip ring module (disposed on the detent of the shaft part). For example, a module line in the region of the end face of the base element can be surrounded by a sealing element, so that the sealing element is pressed against the end of the corresponding groove disposed on the end face of the base element, so as to seal this groove. It can be reliably avoided in this way that a fluid (in particular oil) makes its way from the windings of the rotor to the one or the plurality of slip rings, and/or that metallic dust makes its way from the one or the plurality of slip rings to the windings of the rotor. The robustness and the reliability of the electric machine can be increased in this way.

The base element of the slip ring module can have at least one sealing face which radially encircles the base element and is disposed between the one or the plurality of slip rings and the end face of the base element that faces the connecting region of the shaft part. The sealing face can be used for sealing in relation to oil from the windings of the rotor, and/or in relation to metallic dust from the slip rings.

The rotor shaft can have at least one sealing element which is disposed on the at least one sealing face of the base element of the slip ring module. The sealing element can be configured to shield the one or the plurality of slip rings in relation to a fluid, in particular in relation to oil, which is disposed on the bearing face of the rotor shaft and/or on the windings of the rotor. By providing a sealing element which is disposed so as to encircle the base element of the slip ring module, it can be reliably avoided that fluid (in particular oil) makes its way from the windings of the rotor to the one or the plurality of slip rings, and/or that metallic dust makes its way from the one or the plurality of slip rings to the windings of the rotor. The robustness and the reliability of the electric machine can be increased in this way.

The support element of the shaft part can have a threaded bore on an end face (facing away from the rotor shaft region of the shaft part). The rotor shaft can have a screw which is screwed into the threaded bore of the support element of the shaft part and is configured to fix the slip ring module in the axial direction on the support element of the shaft part. The screw can in particular be configured to press the slip ring module against the detent of the shaft part. A particularly stable fastening of the slip ring module to the shaft part can be ensured in this way.

The rotor shaft in the connecting region of the shaft part can comprise a ring which runs radially about the shaft part and has one or a plurality of (electrically conducting) contact elements for connecting the corresponding one or plurality of module lines (to the windings of the rotor). The one or the plurality of contact elements can in each case be configured as an electrically conducting fork. A particularly efficient electrically conducting attachment of the one or the plurality of slip rings to the windings of the rotor can be ensured in this way. The one or the plurality of slip rings can in turn be coupled in an electrically conducting manner to a current supply by way of a brush module of the electric machine.

The rotor shaft can comprise a sensor module for detecting the angular position of the rotor shaft, which is fastened to the end face of the support element of the shaft part (facing away from the rotor body region). The sensor module herein can be fastened in a particularly efficient manner by means of the abovementioned screw. An efficient and precise placing of the sensor module can be made possible in this way.

Described according to a further aspect is a rotor for an electric machine, which comprises the rotor shaft described in this document. The rotor can furthermore comprise a rotor body having a plurality of salient poles. The rotor body herein can enclose the rotor shaft. Furthermore, the rotor can comprise a plurality of electrically conducting windings about the corresponding plurality of salient poles. The one or the plurality of module lines of the slip ring module of the rotor shaft can be connected in an electrically conducting manner to the plurality of windings.

Described according to a further aspect is an electric machine, in particular a synchronous machine, which comprises the rotor described in this document.

Described according to a further aspect is a (highway) motor vehicle (in particular a passenger motor vehicle or a motor truck or a bus or a motorcycle) which comprises the electric machine described in this document for driving the vehicle.

It is to be noted that the devices, methods and systems described in this document can also be used individually as well as in combination with other devices, methods and systems described in this document. Furthermore, any aspects of the devices, methods and systems described in this document can be combined with one another in many different ways. The features of the claims can in particular be combined with one another in many different ways. Furthermore, features set forth in brackets are to be understood to be optional features.

The invention will be described in more detail hereunder by means of exemplary embodiments.

### BRIEF DESCRIPTION OF THE DRAWINGS

FIG. 1a shows an exemplary electric machine with a cooling jacket;

FIG. 1b shows an exemplary stator lamination (in a view in which the rotation axis of the electric machine or, respectively, the longitudinal axis of the stator is horizontal on the image plane);

FIG. 1c shows a stator assembled from stator laminations (in a view in which the rotation axis of the electric machine or, respectively, the longitudinal axis of the stator runs horizontally within the image plane);

FIG. 1d shows a perspective view of an exemplary rotor body;

FIG. 2a shows a perspective view of an exemplary rotor shaft;

FIG. 2b shows a perspective view of the slip ring module and of the shaft part of the rotor shaft;

FIG. 2c shows a perspective view of the slip ring module;

FIG. 2d shows a perspective view of the shaft part;

FIG. 2e shows a lateral view of the shaft part; and

FIGS. 3a, 3b, 3c, 3d, and 3e show views corresponding to FIGS. 2a to 2e for a rotor shaft having a slip ring module in which the bearing face is disposed on the slip ring module.

### DETAILED DESCRIPTION OF THE DRAWINGS

As set forth at the outset, the present document is focused on providing a particularly stable rotor shaft for a current-energized rotor of an electric machine, in particular of a synchronous machine, which can be efficiently joined to a rotor body. In this context, Fig. la shows an exemplary electric machine 100 when viewed perpendicularly onto the shaft 101 of the electric machine 100, or perpendicularly onto the longitudinal axis of the stator 110, or the rotation axis of the rotor 120 of the electric machine 100, respectively (which run along the z-axis of the Cartesian coordinate system illustrated). The electric machine 100 comprises a stator 110 with a plurality of stator windings 111 which are disposed radially about the rotation axis of the rotor 120 and are specified to generate an electromagnetic rotating field. The stator 110 is surrounded by a housing 135 of the electric machine 100.

The electric machine 100 furthermore comprises the rotor 120 which is driven by the rotating field caused by the stator 110. The rotor 120 is fixedly connected to the shaft 101 which is driven by the electric machine 100 (and can be connected to the rotor shaft of the rotor 120, or corresponds to the rotor shaft of the rotor 120). The rotor 120 comprises a rotor body 122.

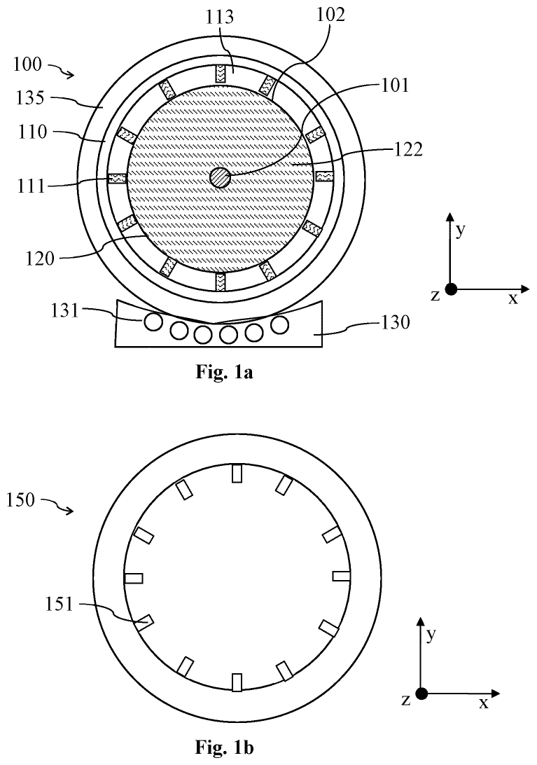

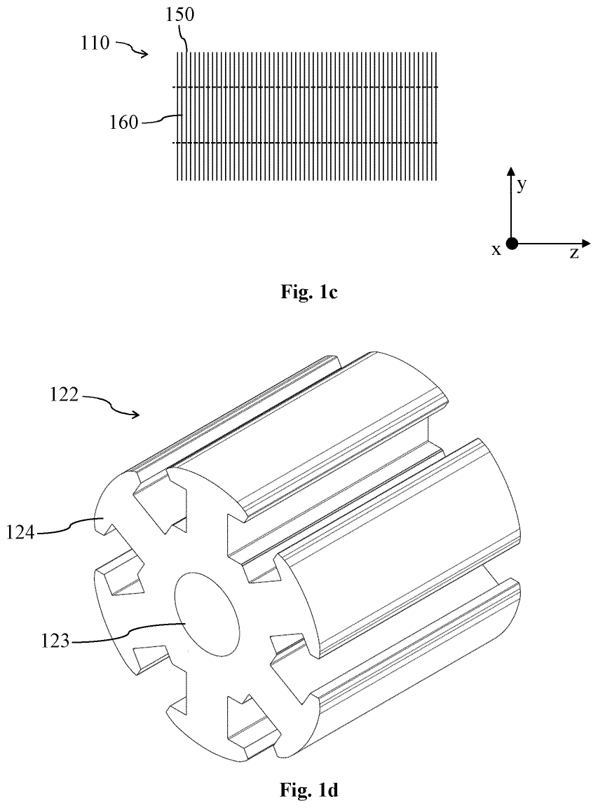

The rotor 120 of an electric machine 100 can have a laminated core of iron (e.g. assembled from mutually isolated sheets) as the rotor body 122. In an analogous manner, the stator 110 can also be assembled from individual (mutually isolated) stator laminations 150 (e.g. iron sheets) (as is illustrated by way of example in FIGS. 1b and 1c). A stator lamination 150 herein can have the shape of a ring (also referred to as the stator yoke) which on the inside facing the center of the ring has webs 151 for corresponding stator windings 111 of the stator 110. One respective web 151 can be provided for each stator winding 111. A stator groove 113 is formed in the typical way as a void between two directly adjacent webs 151, or stator windings 111.

As is illustrated in FIG. 1c, a multiplicity of stator laminations 150 (e.g. 50 or more, or 100 or more, stator laminations 150) can be placed on top of one another along the longitudinal axis of the stator 110 in order to form the stator 110. The stator windings 111 can then be disposed about the individual webs 151 (or about the pole cores formed as a result). As a result of the stator laminations 150 placed on top of one another, a void 160 (which is also referred to as the rotor space in this document) for the rotor 120 is formed in the center.

For cooling, the electric machine 100 can comprise a cooling jacket 130 with cooling lines 131, wherein the cooling jacket 130 can be placed at least partially or completely about the stator 110 and/or about the housing 135 of the electric machine 100 (or about the housing 135 of the electric machine 100 and one or a plurality of other components of the drive train of a vehicle). A coolant (e.g. water) can be directed through the cooling jacket 130, in particular by way of the individual cooling lines 131, so as to discharge the thermal energy, in particular thermal energy from the stator windings 111, created in the operation of the electric machine 100.

FIG. 1d shows an exemplary rotor body 122 of a rotor 120 in a perspective view. The rotor body 122 extends along the rotation axis of the rotor 120, from a first end face to an opposite second end face. The rotor body 122 in the illustrated example has dissimilar magnetic salient poles 124 which are disposed about the rotation axis of the rotor 120. The salient poles 124 can be disposed so as to be distributed uniformly about the rotation axis. A respective coil (i.e. windings), by way of which a magnetic field is generated, can be disposed about the individual salient poles 124. The individual salient poles 124 can thus form magnetic poles of the rotor 120.

The rotor body 122 has a central opening 123, in particular a bore, into which a rotor shaft of the rotor 120 can be introduced. The rotor shaft can be rotatably mounted by way of respective bearing faces on the end faces of the rotor body 122, so as to enable the rotor 120 to rotate. The current lines to the coils on the salient poles 124 of the rotor body 122 can be routed by way of at least one of the bearings of the rotor shaft. For this purpose, the rotor shaft can be configured in multiple parts with separate bearing seats. This typically leads to a reduction in the stability and/or load bearing capability of the rotor 120, and in particular of the rotor shaft. A particularly stable and resilient rotor shaft for a current-energized rotor 120 is described in this document.

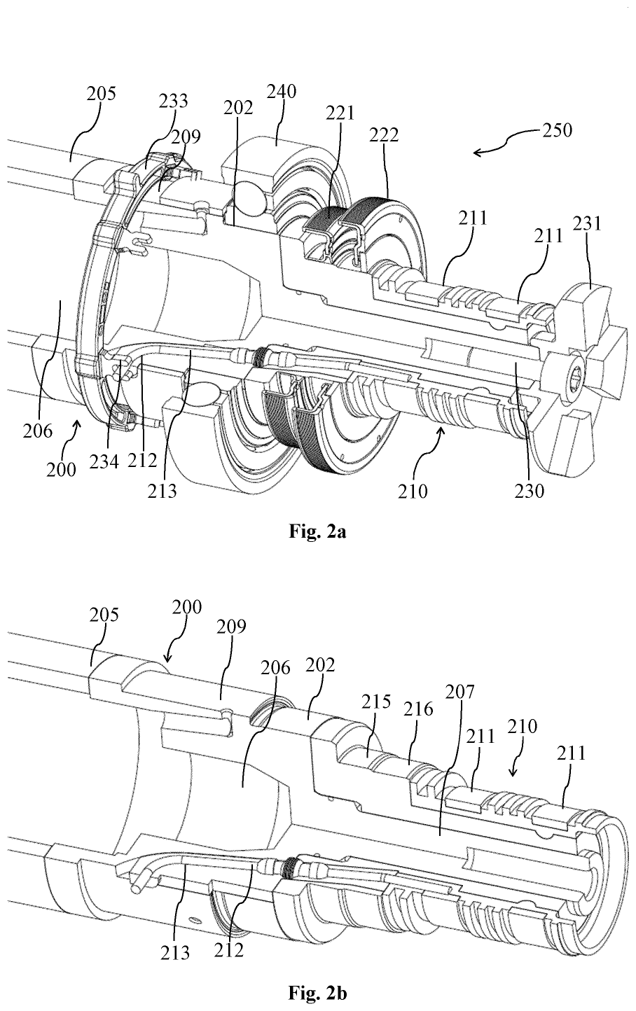

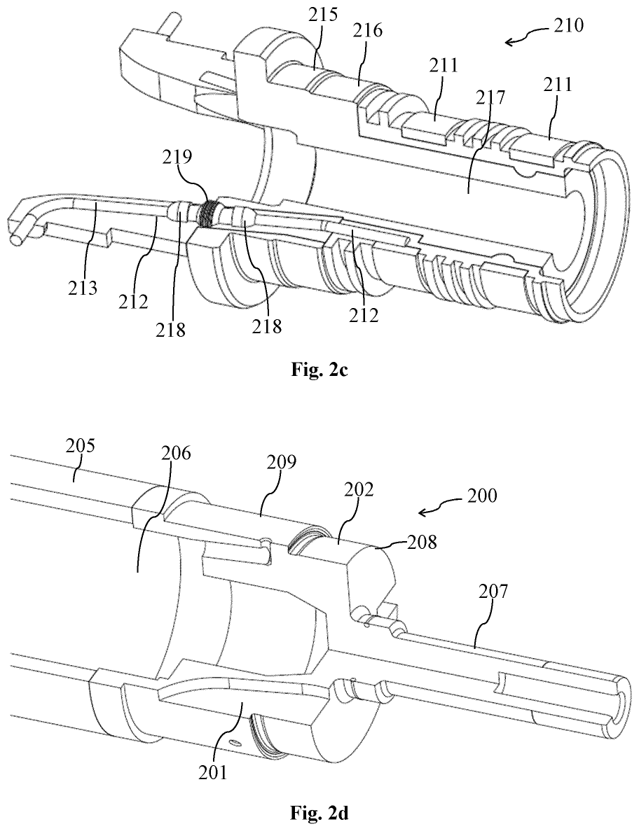

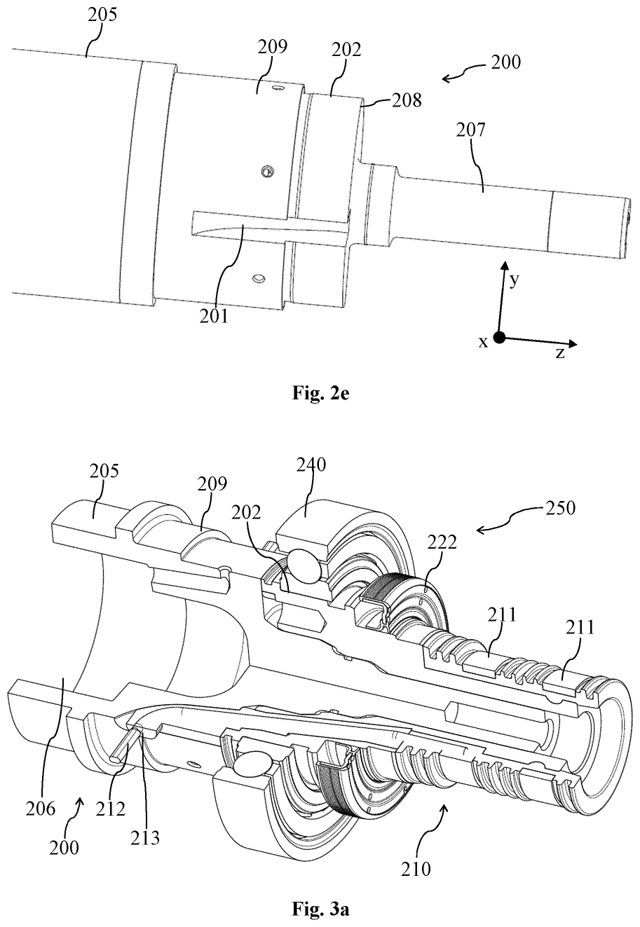

As is illustrated by way of example in FIGS. 2a to 2e, the rotor shaft 200 described in this document comprises a shaft part 200 which can be incorporated in the central opening 123 of the rotor body 122. The central opening 123 can be circular-cylindrical. In an analogous manner, the rotor body region 205 of the shaft part 200, which is disposed within the central opening 123 of the rotor body 122, can be circular-cylindrical. The rotor body 122 and the shaft part 200 can be connected to one another by an interference fit.

The shaft part 200, on a first side which goes beyond the first end face of the rotor body 122, has a first bearing face 202 for mounting the rotor 120. In an analogous manner, the shaft part 200, on the opposite second side which goes beyond the second end face of the rotor body 122, has a second bearing face (not illustrated) for mounting the rotor 120.

Furthermore, the shaft part 200, e.g. on the first side, has a support element 207 to which a slip ring module 210 having one or a plurality of slip rings 211 can be attached. The support element 207 can be circular-cylindrical. In the example illustrated in FIGS. 2a to 2e, the support element 207 is configured as a circular-cylindrical bolt and/or pin which extends in the axial direction, i.e. along the longitudinal and/or rotation axis of the shaft part 200, away from the rotor body region 205 and beyond the first bearing face 202.

The shaft part 200 can furthermore have a detent 208 between the bearing face 202 and the support element 207, which detent 208 is configured to position the slip ring module 210 disposed on the support element 207 in the axial direction. The detent 208 can be configured, for example, as a region which has a larger diameter (measured radially to the rotation axis) than the support element 207.

The shaft part 200 furthermore has at least one groove 201 which extends from the support element 207, via the detent 208, via the bearing face 202, to a connecting region 209 of the shaft part 200, wherein the connecting region 209 is disposed between the rotor body region 205 and the (first) bearing face 202. The groove 201 is configured to receive an electrical line 212 (also referred to as a module line in this document) and optionally a support 213 for the electrical line 212, so that the line 212 runs below the bearing face 202 (in the wall of the shaft part 200). The electrical line 212 can be used to connect in an electrically conducting manner a slip ring 211 of the slip ring module 210 to a contact element 234 of a winding of the rotor 102 (on a contact ring 233). In a preferred example, the shaft part 200 has exactly two grooves 201, in particular two grooves 201 disposed opposite one another, for exactly two electrical lines 212.

The shaft part 200 preferably has a cavity 206. The shaft part 200 can in particular be formed as a hollow cylinder in at least one sub-region. The weight of the rotor shaft 250 can be reduced in this way.

FIG. 2c shows a perspective view of an exemplary slip ring module 210 which is configured to be attached to the support element 207 of the shaft part 200 in order to form a rotor shaft 250 for a current-energized rotor 120.

The slip ring module 210 comprises a base element 217 which is configured to be attached to the support element 207 of the shaft part 200. For this purpose, the base element 217 can be substantially circular-cylindrical and/or rotationally symmetrical. Furthermore, the base element 217 can enclose a cavity which is configured to receive the support element 207 of the shaft part 200. The base element 217 can be configured as a hollow cylinder, for example.

The slip rings 211 of the slip ring module 210 can be disposed on the base element 217, in particular so as to encircle the external face of the base element 217. Furthermore, one or a plurality of sealing faces 215, 216 (encircling the external face of the base element 217) for the disposal of one or a plurality of sealing elements 221, 222 can be disposed between the slip rings 211 and the end face of the base element 217 facing the detent 208 of the shaft part 200. The one or the plurality of sealing elements 221, 222 can be configured to shield oil, which is used to cool the rotor 120, from the slip rings 211 of the slip ring module 210.

For each slip ring 211, the slip ring module 210 furthermore comprises in each case one line 212 which, proceeding from the respective slip ring 211, extends through the wall of the base element 217 to the end face of the base element 217 (facing the detent 208). As from the end face of the base element 217, the respective line 212 is in each case routed onward in the axial direction within a dedicated support 213. The support 213 for a line 212 herein has a shape which complements the corresponding groove 201 in the shaft part 200. The support 213 for a line 212 is preferably configured as an electric isolator. The line 212 herein can be completely encased by the support 213.

The line 212 can be interrupted by contact elements 218, e.g. by a plug connection, on the end face of the base element 217 (facing the detent 208). As a result, it is possible to affix the support 213 conjointly with a part of the line 212 on the end face of the base element 217, so as to provide the entire line 212 from the respective slip ring 211 to a connecting element 234 for the rotor windings.

Alternatively or additionally, an (elastic) sealing element 219, which is configured to seal the respective groove 201 in a fluid-tight manner, for each groove 201 and/or for each line 212 can in each case be disposed on the end face of the base element 217 (facing the detent 208).

The slip ring module 210, in particular the base element 217 of the slip ring module 210, and the shaft part 200, in particular the support element 207 of the shaft part 200, can be configured in such a manner that the slip ring module 210 is fixed to the shaft part 200 by an interference fit. Alternatively or additionally, for fixing the slip ring module 210 in the axial direction, the support element 207 of the shaft part 200 can have a threaded bore 206, into which a screw 230 can be screwed, on the end face that faces away from the bearing face 202, which screw 230 is configured to press the base part 217 of the slip ring module 210 against the detent 208. The screw 230 can furthermore be used to fix a sensor module 231 (e.g. for determining the rotor position) on the rotor shaft 250.

The slip rings 211 and the current supply 212, 213 are thus configured as a slip ring module 210 which can be plugged in axially. The current supply 212, 213 herein can be routed to the control ring 233 of the rotor 120 in grooves 201 below the B-bearing of the rotor shaft 250. As a result, it is possible to provide a single-part shaft part 200. The (single-part) shaft part 200 (typically made of metal) can then be cooled (e.g. using liquid nitrogen) in order to produce the rotor 120 and be fitted in the laminated core 122. The slip ring module 210 can subsequently be assembled on the shaft part 200.

The slip ring module 210 described can have a central sealing region having an interrupted running surface 215, 216 for a sealing system 221, 222. The current supply 212, 213 can furthermore have an elastic seal 219. The slip ring module 210 has separate current supplies 212, 213 (typically exactly two current supplies) having in each case a plastics-material overmolding 213 for an insulating and guiding function. The individual current supplies 212, 213 can be introduced, in particular inserted, axially into corresponding grooves 201 of the single-part shaft part 200. The B-bearing of the rotor shaft 250, i.e. in particular the bearing face 202 of the shaft part 200, is crossed under in the process. The inner race of the bearing (which is optionally of a reinforced configuration) then sits on a bearing seat 202 which is interrupted by the grooves 201.

The slip ring module 210 is configured to ensure a transmission of current to the slip rings 211. The slip rings 211 can be attached to the base element 217 of the slip ring module 210 by way of a plastics material (with a sufficiently large mutual isolating spacing). The support element 207 of the shaft part 200 can be embodied as a pin 207 (shaft stub) reaching up to the (first) end face of the slip ring module 210 in order to improve rotational accuracy and to provide cooling. A sensor 231 for angle detection can be assembled with a relatively high degree of positional accuracy in this region.

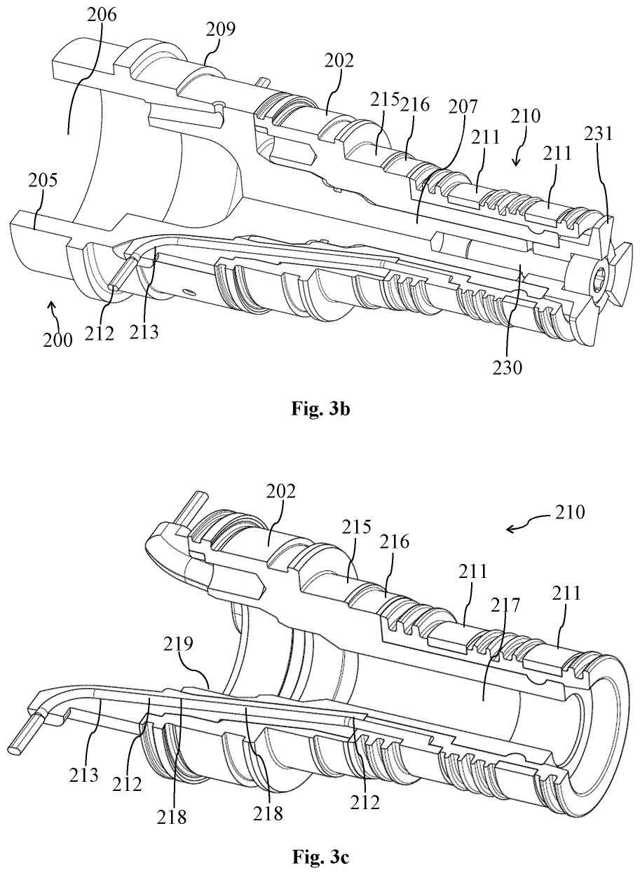

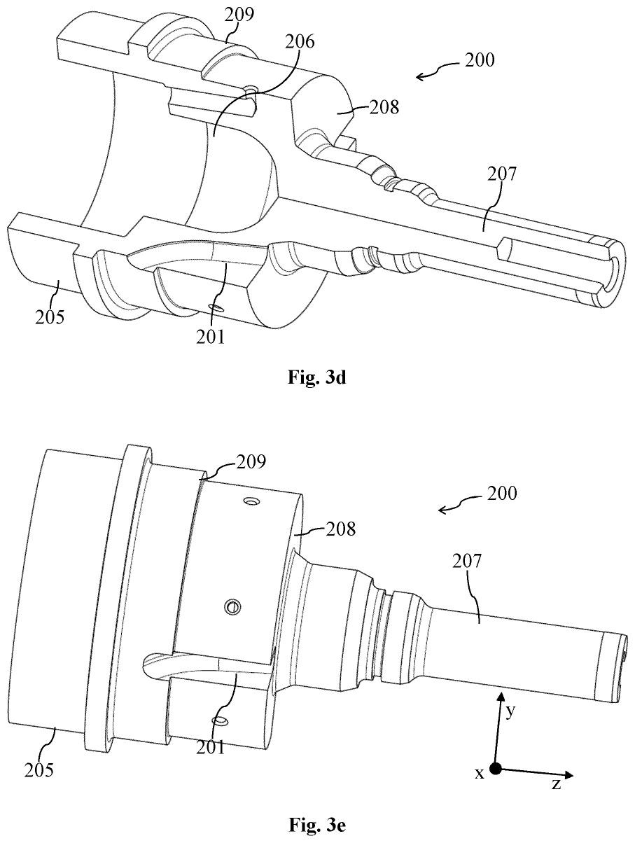

Illustrated in FIGS. 3a to 3e is an alternative design embodiment of the rotor shaft 250. The reference signs from FIGS. 2a to 2e can be applied in an analogous manner to FIGS. 3a to 3e. The explanations pertaining to FIGS. 2a to 2e can in particular also be applied to FIGS. 3a to 3e. The rotor shaft 250 in FIGS. 3a to 3e has a bearing face 202 for mounting the rotor shaft 250, which is disposed on the slip ring module 210. That part of the slip ring module 210 on which the bearing face 202 is disposed herein can be composed of a metal in order to provide an ideally stable bearing face 202. In the example illustrated in FIGS. 3a to 3e, the shaft part 200 of the rotor shaft 250 does not have a bearing face 202 between the connecting region 209 and the detent 208 of the shaft part 200.

A particularly stable and/or robust rotor shaft 250 for the rotor 120 of an electric machine 100 can be provided in an efficient manner as a result of the measures described in this document.

The present invention is not limited to the exemplary embodiments shown. It is to be noted in particular that the description and the figures are intended to visualize the principle of the proposed devices, methods and systems only in an exemplary manner.

1-14. (canceled)

15. A rotor shaft for a rotor of an electric machine, wherein the electric machine is a current-energized electric synchronous machine, the rotor shaft comprising:
a shaft part that extends in an axial direction along a rotation axis of the rotor, and that comprises:
a rotor body region for disposal in a rotor body in a central opening of the rotor body of the rotor;
a support element which follows in the axial direction; and
one or more grooves that run in the axial direction from a connecting region of the shaft part to the support element;
a slip ring module having a base element having one or more slip rings, wherein the slip ring module is disposed on the support element of the shaft part; and
one or more electrically conducting module lines which extend from the corresponding one or more slip rings within the corresponding one or more grooves of the shaft part to the connecting region of the shaft part; and
a bearing face for mounting the rotor shaft, which is disposed on the shaft part and/or on the slip ring module, wherein the bearing face in terms of the axial direction is disposed between the connecting region of the shaft part and the one or more slip rings of the slip ring module.

16. The rotor shaft according to claim 15, wherein the bearing face encloses the one or more grooves and the one or more electrically conducting module lines in a radially encircling manner about the axial direction.

17. The rotor shaft according to claim 15, wherein
the bearing face is disposed between the connecting region and the support element on the shaft part; or
wherein the bearing face is disposed on the slip ring module on an end of the slip ring module that faces the connecting region of the shaft part.

18. The rotor shaft according to claim 15, wherein
the one or more electrically conducting module lines are in each case disposed in an electrically isolating support;
the one or more supports, proceeding in each case from an end face of the base element of the slip ring module, extend in the axial direction toward the connecting region of the shaft part; and
the one or more grooves are configured to receive the corresponding one or more supports.

19. The rotor shaft according to claim 18, wherein one or more sealing elements for sealing the corresponding one or more grooves of the shaft part in a fluid-tight manner are disposed on the end face of the base element of the slip ring module.

20. The rotor shaft according to claim 15, wherein
the shaft part has a detent for an end face of the base element of the slip ring module, which is disposed between the connecting region and the support element; and
the one or more grooves begin at the detent and terminate in the connecting region.

21. The rotor shaft according to claim 15, wherein the base element of the slip ring module has at least one sealing face which radially encircles the base element and is disposed between the one or more slip rings and an end face of the base element that faces the connecting region of the shaft part.

22. The rotor shaft according to claim 21, wherein the rotor shaft has at least one sealing element:
which is disposed on the at least one sealing face of the base element of the slip ring module, and
which is configured to shield the one or more slip rings in relation to an oil which is disposed on the bearing face of the rotor shaft.

23. The rotor shaft according to claim 15, wherein
the support element of the shaft part has a threaded bore on an end face; and
the rotor shaft has a screw which is screwed into the threaded bore of the support element of the shaft part and is configured to fix the slip ring module in the axial direction on the support element of the shaft part, whereby the slip ring module is pressed against a detent of the shaft part for an end face of the base element of the slip ring module by the screw.

24. The rotor shaft according to claim 15, wherein
the support element is configured as a pin which extends in a radial direction away from a detent of the shaft part; and/or
wherein the base element of the slip ring module has a cavity which is configured to receive the support element of the shaft part, in particular in such a manner that an interference fit is formed between the base element of the slip ring module and the support element of the shaft part.

25. The rotor shaft according to claim 15, wherein
the rotor shaft in the connecting region of the shaft part comprises a ring which runs radially about the shaft part and has one or more contact elements for connecting the corresponding one or more module lines.

26. The rotor shaft according to claim 15, wherein
the rotor shaft comprises a sensor module for detecting an angular position of the rotor shaft, which is fastened to an end face of the support element of the shaft part.

27. A rotor for an electric machine, wherein the rotor comprises:
a rotor body having a plurality of salient poles;
a plurality of electrically conducting windings about the corresponding plurality of salient poles; and
the rotor shaft according to claim 15, which is enclosed by the rotor body, wherein the one or more module lines of the slip ring module of the rotor shaft are connected in an electrically conducting manner to the plurality of windings.

28. An electric machine comprising:
the rotor according to claim 27.
